(19) United States
(12) Patent Application Publication
(10) Pub. No.: US 2025/0207681 A1
(43) Pub. Date: Jun. 26, 2025

(54) GAS VALVE ASSEMBLY

(71) Applicant: Planet Safety System Technologies LLC, Monroe, NY (US)

(72) Inventors: Brian M Corcoran, Monroe, NY (US); Michael W Haynes, Hackensack, NJ (US)

(21) Appl. No.: 19/081,860

(22) Filed: Mar. 17, 2025

Related U.S. Application Data
(63) Continuation-in-part of application No. 17/813,179, filed on Jul. 18, 2022, now Pat. No. 12,253,185.
(60) Provisional application No. 63/203,485, filed on Jul. 24, 2021.

(51) Int. Cl. F16K 31/06; F16K 31/08

(52) U.S. Cl. CPC F16K 31/0665; F16K 31/0675; F16K 31/082

(57) ABSTRACT

A valve assembly consists essentially of a valve body having an inlet port and an outlet port; a valve retainer at least partially housed within the valve body; a valve poppet positioned within the valve body; a magnet affixed within the valve body near the valve body inlet port; and a solenoid coil mounted around the valve body.

### CROSS-REFERENCE TO RELATED APPLICATIONS

This application is a continuation-in-part of U.S. Nonprovisional application Ser. No. 17/813,179, filed Jul. 18, 2022, set to issue as U.S. Pat. No. 12,253,185, which claims the benefit of priority of U.S. Provisional Patent Application No. 63/203,485, which is titled “Gas Valve” and was filed on Jul. 24, 2021, the disclosure of each of which is incorporated by reference in their entirety herein.

### FIELD OF THE INVENTION

This application is related to gas valve assemblies. More particularly, the application is directed to simplified gas valve assemblies having a valve poppet and a solenoid coil for controlling the location of the valve poppet.

### SUMMARY

The following presents a simplified summary of the disclosure in order to provide a basic understand of some aspects of the invention. This summary is not an extensive overview. It is not intended to identify critical elements of the invention or to delineate the scope of the invention. Its sole purpose is to present some concepts of the invention in a simplified form as a prelude to the more detailed description that is presented elsewhere herein.

According to one embodiment, a valve assembly consists essentially of a valve body having an inlet port and an outlet port; a valve retainer at least partially housed within the valve body; a valve poppet positioned within the valve body; a magnet affixed within the valve body near the valve body inlet port; and a solenoid coil mounted around the valve body.

In another embodiment, a valve assembly includes a valve body having an inlet port and an outlet port; a valve retainer at least partially housed within the valve body; a valve poppet positioned within the valve body; a magnet arranged within the valve body near the valve body inlet port; and a solenoid coil mounted around the valve body.

According to still another embodiment, method for operating a valve assembly first includes providing a valve assembly. The valve assembly consists essentially of a valve body having an inlet port and an outlet port and comprising a ledge and a valve seat; a magnet retainer within the valve body, the magnet retainer housing a magnet; a valve retainer at least partially housed within the valve body, wherein the valve retainer maintains the magnet retainer in position within the valve body; a seal positioned between the magnet retainer and the valve retainer; a valve poppet positioned within the valve body between the valve body outlet port and the magnet retainer; at least one pin extending through the magnet retainer to guide movement of the valve poppet; a solenoid coil mounted around the valve body, the solenoid coil being battery operated; and a micro charger for maintaining the life of the battery. The method further includes causing a pulse of electrical current of a first polarity to be sent to the solenoid coil, thereby inducing a first magnetic field. The first magnetic field causes the valve poppet to be temporarily magnetized such that the valve poppet is attracted to the magnet within the magnet retainer. The magnet holds the valve poppet at the magnet retainer such that the valve assembly is in an open configuration. Finally, the method includes causing a pulse of electrical current of a second polarity to be sent to the solenoid coil, thereby inducing a second magnetic field. The second magnetic field causes the valve poppet to be temporarily magnetized such that the valve poppet is repelled by the magnet within the magnet retainer. When repelled away from the magnet, the valve poppet sits atop the valve seat such that the valve assembly is in a closed configuration. In the open configuration, fluid is permitted to flow through the valve assembly. In the closed configuration, fluid is prevented from flowing through the valve assembly.

### BRIEF DESCRIPTION OF THE DRAWINGS

FIG. 1 is a cross-sectional view of a gas valve assembly in a closed position according to another embodiment of the invention.

FIG. 2 is a detailed view of a valve seat of the gas valve assembly of FIG. 1.

FIG. 3 is a detailed view of a valve retainer of the gas valve assembly of FIG. 1.

FIG. 4A is a detailed view of a magnet retainer assembly of the gas valve assembly of FIG. 1.

FIG. 4B is a detailed view of the magnet retainer cap of FIG. 4A.

FIG. 4C is a detailed view of the magnet retainer magnet holder of FIG. 4A.

FIG. 5 is a detailed view of a guide pin of the gas valve assembly of FIG. 1.

FIG. 6 is a cross-sectional view of a gas valve assembly in a closed position according to an embodiment of the invention.

FIG. 7 is a cross-sectional view of the gas valve assembly of FIG. 6 in an open position.

FIG. 8 is a bottom view of valve retainer of the gas valve assembly of FIG. 6.

FIG. 9 is a cross-sectional view of a valve assembly according to an embodiment of the invention, wherein the valve is in an open position.

FIG. 10 is a cross-sectional view of the valve assembly of FIG. 9, wherein the valve is in a closed position.

FIG. 11 is a cross-sectional view of a valve body of the valve assembly of FIG. 9.

FIG. 12 is a cross-sectional view of a valve body plug of the valve assembly of FIG. 9.

FIG. 13 is a cross-sectional view of a solenoid coil assembly of the valve assembly of FIG. 9.

FIG. 14 is a cross-sectional view of a valve poppet of the valve assembly of FIG. 9.

### DETAILED DESCRIPTION

Electromechanical valves have been used for years. However, these valves are often complicated and are prone to failure, particularly if the valve is not operated according to the pressure rating of the valve. It would be helpful to have a valve that is exceedingly simple to produce and operate.

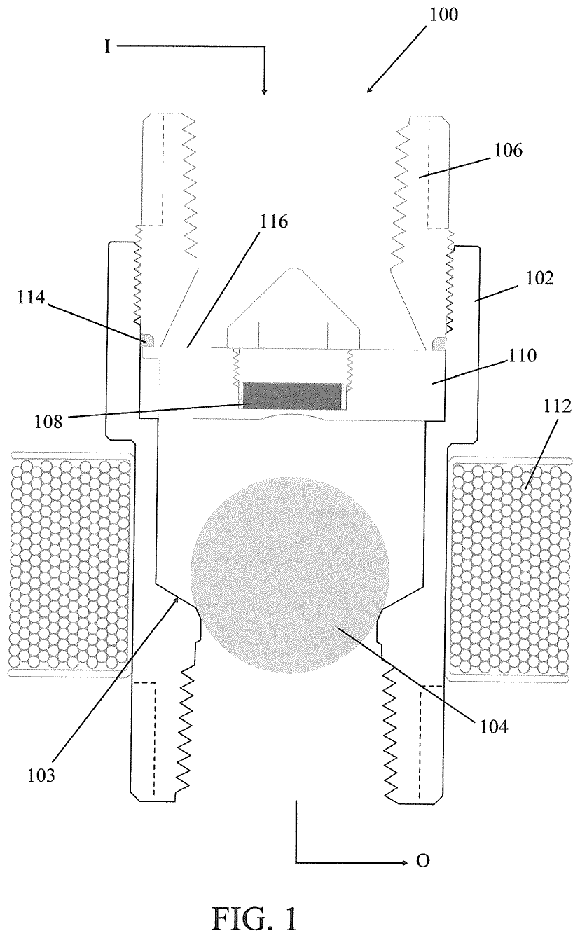

With reference now to the figures, embodiments of gas valve assemblies are described. FIG. 1 shows a cross-sectional view of a gas valve assembly 100. The gas valve assembly 100 has an inlet end I, which is connected to a gas supply line, and an outlet end O where the gas exits the valve assembly 100. The valve assembly 100 consists essentially of a valve body 102, valve poppet 104, valve retainer 106, magnet 108, magnet retainer 110, and solenoid coil 112. The gas valve assembly 100 may include one or more guide pins 116. The gas valve assembly 100 may further include one or more seals 114 such as an O-ring type seal. Further, one or more retaining rings may be utilized to hold one or more of the gas valve components to or within the valve body 102.

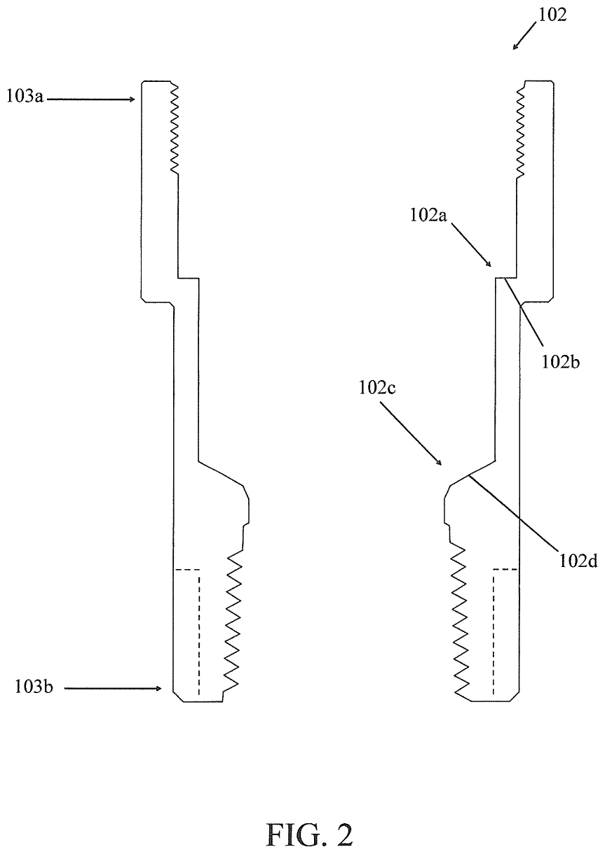

FIG. 2 illustrates the valve body 102. The valve body 102 has an upper end 103a and a lower end 103b. The valve body 102 includes a ledge 102a and a valve seat 102c. The ledge 102a may extend partially, substantially, or entirely around the inner circumference near the upper end 103a of the valve body 102 and defines a substantially flat surface 102b. The valve seat 102c may also extend partially, substantially, or entirely around the inner circumference of the valve body 102. The valve seat 102c defines an angled surface 102d, wherein the angle is directed toward the lower end 103b of the valve body 102. Preferably, the valve body 102 is constructed from a non-magnetic material.

The valve poppet 104 sits within the valve body 102 atop the valve seat 102c. The valve poppet 104 may be, for example, a metal ball having ferromagnetic properties. In embodiments, the valve poppet 104 is a steel ball, although other ferromagnetic metals may be utilized.

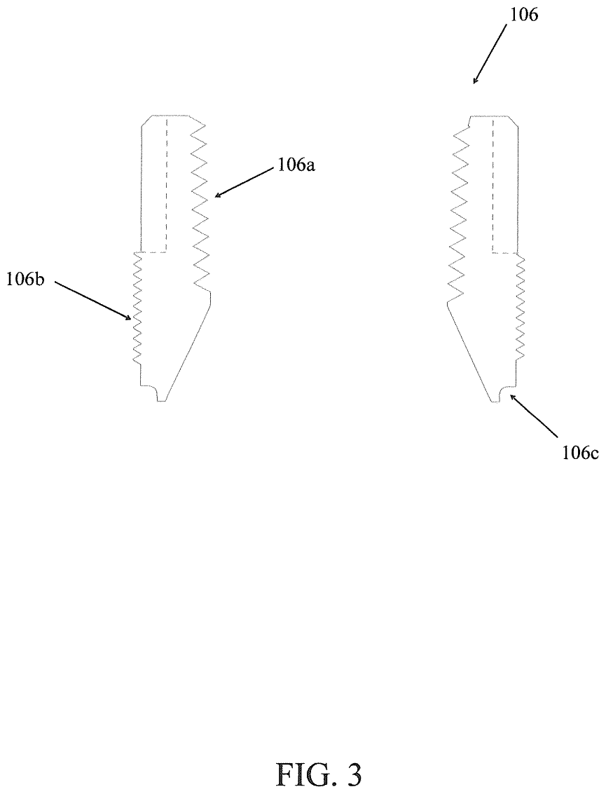

Moving on, FIG. 3 illustrates the valve retainer 106. The valve retainer 106 has inner threading 106a and outer threading 106b. The inner threading 106a allows the valve assembly 100 to connect to piping at the inlet end I. The outer threading 106b corresponds to threading at the upper end 103a of the valve body 102 and allows the valve retainer 106 to be joined to the valve body 102. A notch 106c in the valve retainer 106 provides an opening for a seal, such as an O-ring. As shown in FIG. 1, the seal 114 is located between the valve retainer 106 and the valve body 102 in an installed configuration.

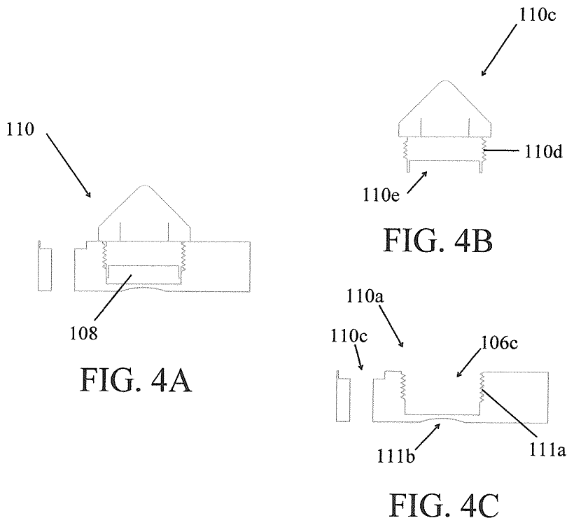

The magnet retainer 110 is shown generally in FIG. 4. The magnet retainer 110 includes a magnet holder 110a and a magnet holder cap 110b. With specific reference to FIG. 4C, the magnet holder 110a may include a magnet seat 111 configured to hold the magnet 108. An inside perimeter 111a of the magnet seat 111 may be threaded. A section 111b of the magnet seat 111 may be hollowed out or furrowed to allow magnetic forces to act through the magnet retainer 110.

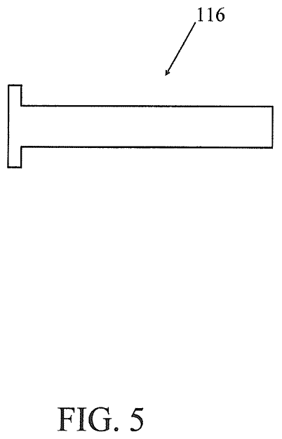

The magnet holder 110a may include one or more holes 110b, each hole being configured to receive a pin 116 (see FIG. 5). The pins 116 may serve as guides to keep the poppet 104 centered within the valve body 102.

The magnet holder cap 110c is illustrated specifically in FIG. 4B, and may include corresponding threads 110d to secure the cap 110c to the magnet holder 110A. As illustrated in FIG. 4B, the magnet holder cap 110c may have a hollow interior 110e such that, when the cap 110c is mated with the magnet holder 110a, the magnet 108 fits at least partially within the hollow interior 110e.

The magnet 108 is preferably a permanent magnet.

As illustrated in FIG. 1, the magnet retainer 110 sits within the valve body 102 atop the ledge 102a. The valve retainer 106 mates with the valve body 102 (e.g., via the respective corresponding threadings) thereby holding the magnet retainer 110 in place. The magnet 108 sits within the magnet retainer 110, and specifically within the magnet seat 111, and is held in place by the magnet holder cap 110c.

The solenoid coil 112 is mounted around the valve body 102 as shown in FIG. 1. The solenoid coil 112 may be held in place with a retaining ring, such as a spiral-type retaining ring, for example.

In operation, the location of the poppet 104 defines whether the valve assembly 100 is open or closed. In a closed state, the poppet 104 rests on the valve seat 103 as shown in FIG. 1. The poppet 104 may be held in the closed position by gravity. In other words, the weight of the poppet 104 may keep the poppet 104 resting on the valve seat 103. Additionally, the pressure differential between the inlet port I and the output port O may help to maintain the valve assembly 100 in the closed position. In the closed position, gas cannot flow through the valve 100.

To move from the closed position to the open position, the valve poppet 104 is raised off the valve seat 103 and is held in the open position via the magnet 108. More specifically, when the position of the valve 100 is to be changed, a direct current pulse is sent to the solenoid coil 112. The coil 112 produces a magnetic field as the current passes through. And as the solenoid coil 112 surrounds the poppet 104, activation of the coil 112 causes the poppet 104 to briefly act as an electromagnet. In other words, the magnetic field produced within the coil 112 briefly magnetizes the valve poppet 104. As is known to those of skill in the art, the polarity of the current sent through the solenoid coil 112 determines whether the poppet 104 is attracted to, or repelled away from, the magnet 108. Therefore, if it desired to move the poppet 104 towards the magnet 108, current, of proper polarity, is sent through the coil 112 causing the poppet 104 to be briefly magnetized. The poppet 104 is only magnetized when an electric current moves through the coil 112. The magnetic field produced within the poppet 104 allows the poppet 104 to be attracted to the magnet 108. This attraction is strong enough to cause the poppet 104 to move off the valve seat 103, and the magnet 108 is strong enough to hold the poppet 104 in the open position. The magnet 108 will hold the poppet 104 indefinitely. In the open position, gas is allowed to flow through the valve 100.

To move the valve 100 back into the closed position, a brief pulse of current, of the correct polarity, is sent through solenoid coil 112. This will again cause the poppet 104 to briefly act as an electromagnet. In this case, the polarity of the current through the coil 112 is such that the poppet 104 has the same polarity as the magnet 108. This causes a repellent force between the magnet 108 and the poppet 104, which forces the poppet 104 back toward the valve seat 103. Once the poppet 104 is seated on the valve seat 103, the natural attractive force of the magnet 108 is insufficient to attract the poppet 104 as the poppet 104 is no longer magnetized.

The valve assembly 100 is designed for simple manufacture and operation. Accordingly, the valve 100 may rely on gravity, as described above, to keep the poppet 104 in the valve seat 103 in the closed position. In embodiments where the valve 100 relies on gravity, the valve 100 may be mounted in a substantially vertical position with the inlet port I generally at the top and the outlet port O generally at the bottom. The valve 100 may be used in a primarily stationary application and may but need not necessarily be limited to low pressure applications.

In embodiments, the valve 100 may be configured such that a second permanent magnet (e.g., of opposite polarity from the permanent magnet 108) retains the poppet 104 in the closed position. For example, a second permanent magnet (which may be a single magnet or a plurality of magnets) may be positioned on or within the valve body 102 substantially adjacent the valve seat 103. The second permanent magnet may be particularly useful where it is desirable to mount the valve 100 in a horizontal rather than a vertical position. Additionally, if fluid flow is in an atypical direction, e.g., from low to high instead of high to low, the valve 100 may be flipped such that the outlet port O is at the top and the inlet port I is at the bottom.

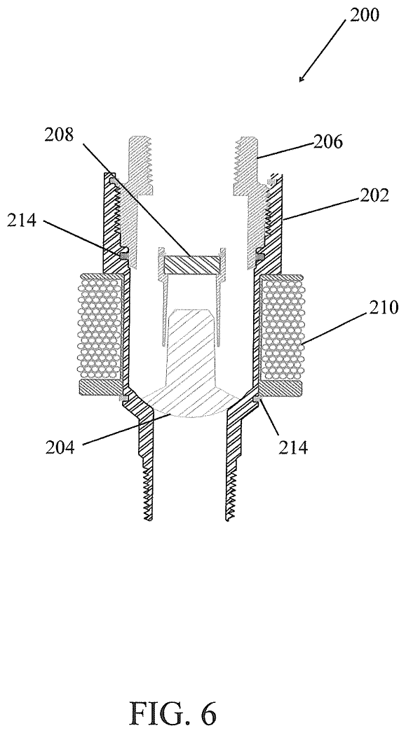

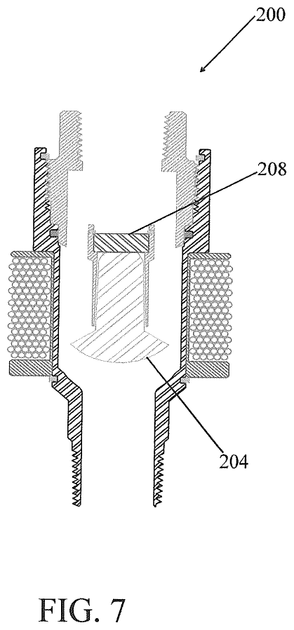

FIGS. 6-7 illustrate a cross-sectional view of a gas valve assembly 200 which is substantially similar to the gas valve 100 except as specifically noted and/or shown, or as would be inherent. Further, those skilled in the art will appreciate that the embodiment 100 (and thus embodiment 200) may be modified in various ways, such as through incorporating all or part of any of the various described embodiments. For uniformity and brevity, reference numbers between 200 and 299 may be used to indicate parts corresponding to those discussed above numbered between 100 and 199 (e.g., valve body 202 corresponds generally to valve body 102), though with any noted or shown deviations.

The gas valve assembly 200 consists essentially of a valve body 202, valve poppet 204, valve retainer 206, magnet 208, and solenoid coil 212. The gas valve assembly 200 may further include one or more seals 214, such as an O-ring type seal. Further, one or more retaining rings may be utilized to hold one or more of the gas valve components on or within the valve body 202. Particularly, a retaining ring may be used to secure the solenoid 210 to the valve body 202.

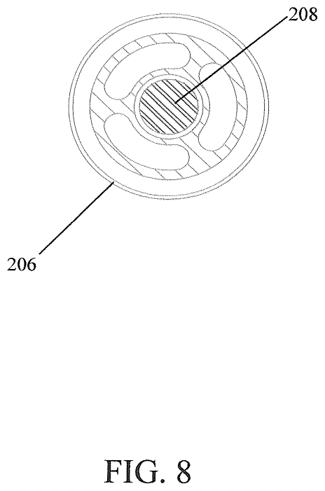

The gas valve assembly 200 in FIG. 6 is shown in a closed position. Conversely, FIG. 7 shows the gas valve assembly 200 in an open position. FIG. 8 is a bottom view of the valve retainer 206.

Operation of the gas valve assembly 200 is substantially the same as operation of the gas valve assembly 100. Moreover, as with gas valve assembly 100, the gas valve assembly 200 may incorporate additional magnets 208 such that the valve 200 can be used in a reverse (e.g., upside-down) configuration and/or horizontally.

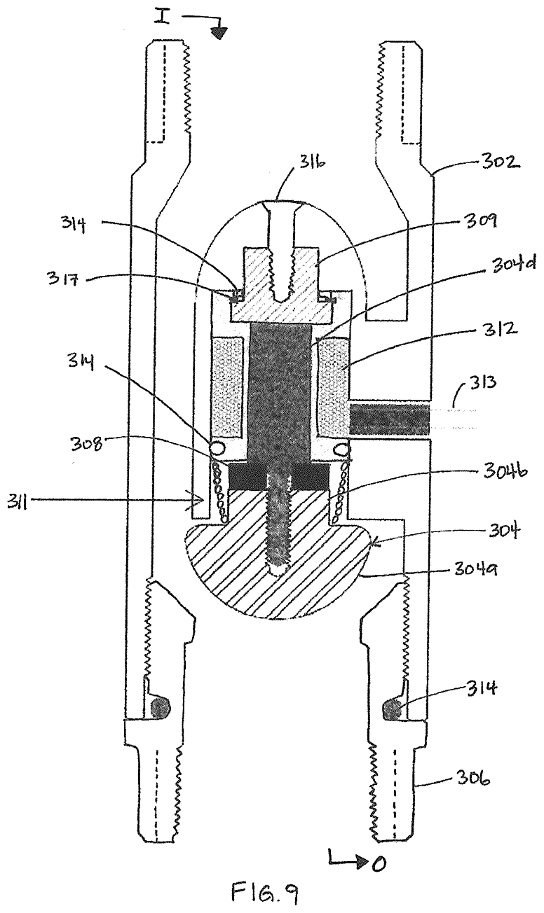

FIGS. 9-15 illustrate a cross-sectional view of a gas valve assembly 300 which is substantially similar to the gas valve 100 except as specifically noted and/or shown, or as would be inherent. Further, those skilled in the art will appreciate that the embodiment 100 (and thus embodiment 300) may be modified in various ways, such as through incorporating all or part of any of the various described embodiments. For uniformity and brevity, reference numbers between 300 and 399 may be used to indicate parts corresponding to those discussed above numbered between 100 and 199 (e.g., valve body 302 corresponds generally to valve body 102), though with any noted or shown deviations.

With reference now to FIGS. 9-15, the gas valve assembly 300 has an inlet end I, which is connected to a gas supply line, and an outlet end O where the gas exits the valve assembly 300. The valve assembly 300 comprises or consists essentially of a valve body 302, valve poppet 304, magnet 308, bobbin 307, retainer plug 309, assist spring 311, and solenoid coil 312.

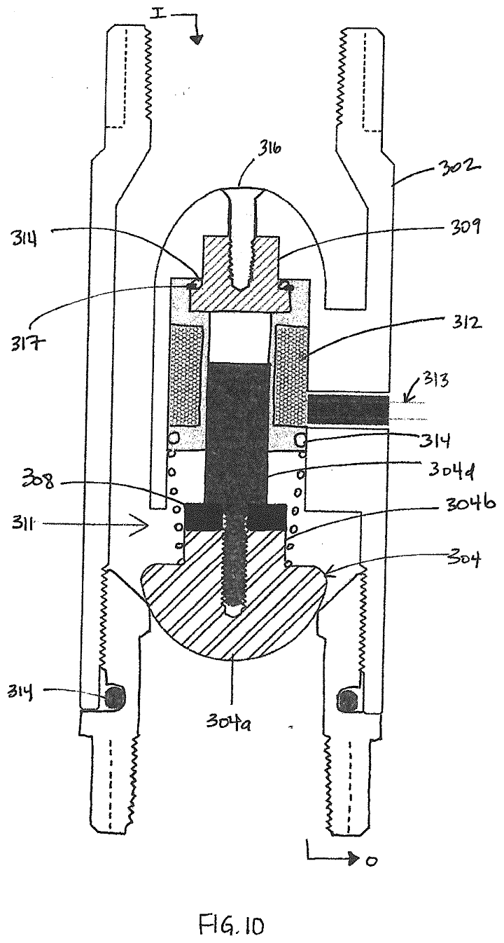

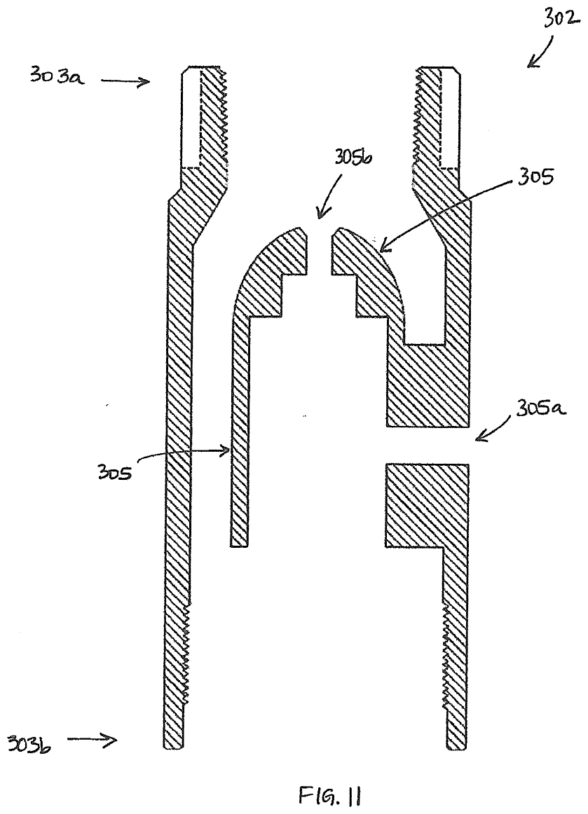

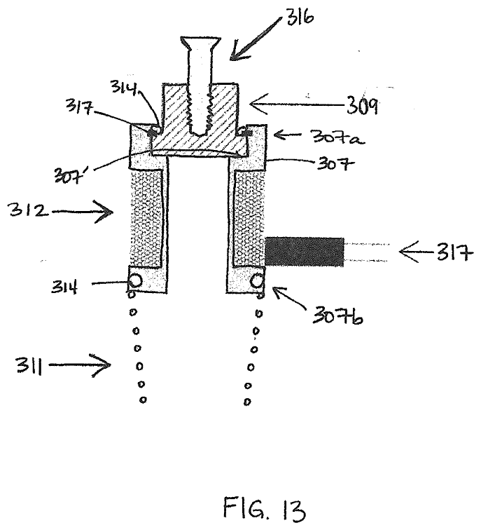

FIG. 11 is a cross-section view of the valve body 302. The valve body 302 has an upper end 303a and a lower end 303b. A coil holder 305 is formed integrally with the valve body 302 and is located between the upper end 303a and the lower end 303b. The coil holder 305 is configured to retain the coil bobbin 307, the coil 312, and the retainer plug 309 as shown in the drawings, specifically FIGS. 9 and 10. The valve body 302 includes a first opening 305a in the vicinity of the coil holder 305. The opening 305a allows coil connecting wires 313 to pass through the valve body 302 and be operatively coupled to the coil 312. A second opening 305b is formed near the top of the coil holder 305. A fastening mechanism 316, such as a screw, is inserted through the opening 305b and engages with the retainer plug 309 to hold the retainer plug 309 (and thus other parts of the assembly 300, and specifically the coil assembly) in position. The coil assembly is described in greater detail below with reference to FIG. 13. Preferably, the valve body 302 is constructed from a non-magnetic material.

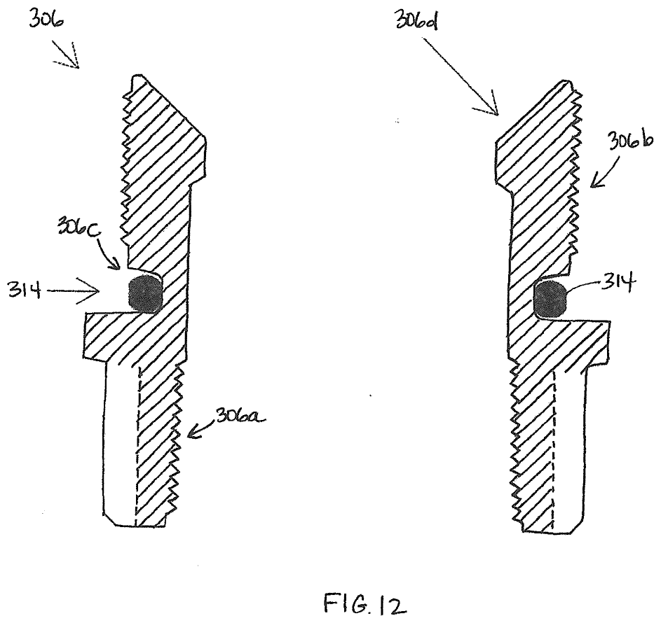

Moving on, FIG. 12 illustrates a valve body plug 306. The valve body plug 306 has inner threading 306a and outer threading 306b. The inner threading 306a allows the valve assembly 300 to connect to piping at the outlet end O. The outer threading 306b corresponds to threading at the lower end 303b of the valve body 302 and allows the valve body plug 306 to be joined to the valve body 302. A notch 306c in the valve body plug 302c provides an opening for a seal 314, such as an O-ring. As shown in FIG. 9, the seal 314 is located between the valve body plug 306 and the valve body 302 in an installed configuration. The valve body plug 306 further includes a poppet seat 306d defined by an angled wall upon which the poppet 304 sits when the valve 300 is in a closed position, as shown in FIG. 10.

FIG. 13 illustrates the coil assembly that fits within the valve body 302, and specifically, within the coil holder 305. The coil assembly includes the bobbin 307, sized to fit within the coil holder 305 and the retainer plug 309 which fits within a seat 307′ at a first end 307a of the bobbin 307. The bobbin 307 and/or the retainer plug 309 may be equipped with one or more snap rings 317 which hold the bobbin 307 in engagement with the retainer plug 309. A seal 314, such as an O-ring, may be provided between the retainer plug 309 and the bobbin 307. The retainer plug 309 includes internal threading 309a to engage with threading on the fastening mechanism 316. When installed, the fastening mechanism 316 holds the retainer plug 309, and therefore the bobbin 307, in position with respect to the coil holder 305. The retainer plug 309 is preferably made of a ferromagnetic material.

The solenoid coil winding 312 is provided around the body of the bobbin 307, and in particular, in a recessed area of the bobbin 307. Coil connection wires 313 are operably coupled to the coil 312 (through the opening 305a in the valve body 302) as is known to those of skill in the art. An additional seal 314 may be provided at an opposite end 307b of the bobbin 307 to provide a seal between the bobbin 307 and the valve body coil holder 305.

A spring 311 which may be, for example, a conical spring, extends from the opposite end 307b of the bobbin 307. Preferably, the distal end of the spring 311 has a diameter that is substantially equal to or just slightly greater than a diameter of a protruding portion 304b of the poppet 304 such that the spring 311 fits therearound. The spring 311 may be fastened to the poppet 304, e.g., via an adhesive, weld, or mechanical attachment such as a rivet, or may be held in engagement via a friction fit. In an embodiment, the spring 311 may be configured to bias the poppet 304 towards the closed position in a natural state. In another embodiment, the spring 311 may be configured to bias the poppet 304 towards the open position in a natural state. Importantly, the spring 311 allows the valve 300 to be mounted, and operated, in any position.

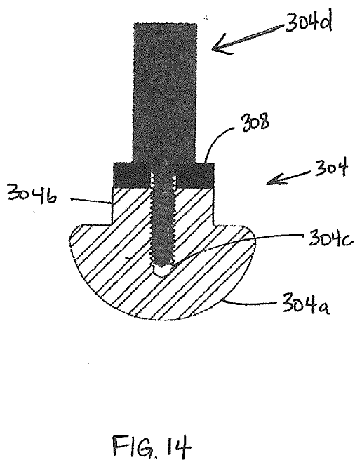

FIG. 14 illustrates the poppet assembly in greater detail. In this embodiment, the poppet 304 has a composite design. Here, the poppet 304 includes a poppet bottom portion 304a and a neck portion 304b. A magnet 308 is situated atop the poppet 304, and a valve stem 304d is threadably received by the poppet 304, which has internal threads 304c, thereby holding the magnet 308 in place. In embodiments, the poppet 304 is made from any non-magnetic material, such as a non-magnetic metal or a plastic. Conversely, the valve stem 304d is preferably a ferromagnetic material.

Returning to FIGS. 9 and 10, the valve assembly 300 is illustrated in the open position (FIG. 9) and the closed position (FIG. 10). As shown, the coil assembly fits generally within the coil holder 305 and is maintained in position via the fastener 316. The spring 311 engages with the poppet 304 to bias the poppet 304 towards the closed position, shown in FIG. 10. In the closed position, the poppet 304 rests atop the valve poppet seat 306d, thereby preventing fluid passing through the valve 300 to the outlet O. Conversely, in the open position, shown in FIG. 9, the poppet 304 is held close to the coil holder 305, thereby allowing fluid to pass through the valve to the outlet O.

Operation of the gas valve assembly 300 is substantially the same as operation of the gas valve assembly 100. To move from the closed position to the open position, the valve poppet 304 is raised off the poppet seat 306d and is held in the open position. More specifically, when the position of the poppet 304 is to be changed, a direct current pulse is sent to the solenoid coil 312. The coil 312 produces a magnetic field as the current passes through. Activation of the coil 312 induces a magnetic field within the coil 312. The magnetic field within the coil acts upon the stem 304d (and the retainer plug 309) causing the stem 304d, and thereby the poppet 304, to come into contact with the retainer plug 309 thus opening the valve (as shown in FIG. 9). As is known to those of skill in the art, the polarity of the current sent through the solenoid coil 312 may determine whether the poppet 304 is attracted to, or repelled away from, the retainer plug 309. Additionally, as described above, the assist spring 311 may bias the poppet 304 towards the closed position in its natural state.

Therefore, to move the poppet 304 back into the closed position, current may be cut off from the solenoid coil 312. This will allow the poppet 304 return to the closed position. The spring 311 will maintain the poppet 304 seated on the valve seat 306d.

As discussed above, the addition of the spring 311 allows the valve 300 to be mounted in virtually any position. In some instances, it may be desirable to mount the valve 300 in a horizontal rather than a vertical position. Additionally, if fluid flow is in an atypical direction, e.g., from low to high instead of high to low, the valve 300 may be flipped such that the outlet port O is at the top and the inlet port I is at the bottom. Regardless of the mounting position of the valve 300, operation remains virtually the same.

The valve assembly 100, 200, 300 may be utilized in a meter system, such as a system for monitoring and controlling the flow of gas or water. The valve assembly 100, 200, 300 may be used in other systems, including any system that utilizes a valve to control fluid flow.

In embodiments, the solenoid coil 112, 212, 312 may be battery operated. To maintain the health of the batteries, the valve assembly 100, 200, 300 may be equipped with a micro charger. The micro charger may be connected to a power source as is known to those of skill in the art. In further embodiments, the solenoid coil 112, 212, 312 may be powered by alternating current (e.g., via hardwire to a building's power supply). Preferably, though not necessarily, the coil 112, 212, 312 may be wired for 110 volt operation.

The flow of current may be controlled automatically or deliberately by a user via a software system. Accordingly, the valve assembly 100, 200, 300 may be equipped with various features that allow for operable connection with the software system. The artisan will understand that the valve embodiments 100, 200, 300 disclosed herein may include or have associated therewith electronics (e.g., a computing system, data servers, one or more processors, etc., executing one or more lines of code). The electronics may be used to control and modify the operation of the valve 100, 200, 300 or components thereof (e.g., directing a motor and/or actuator function). In some example embodiments, processor or processors may be configured through particularly configured hardware, such as an application specific integrated circuit (ASIC), field-programmable gate array (FPGA), etc., and/or through execution of software to allow the valve assembly 100, 200, 300 to function in accordance with the disclosure herein. Likewise, the valve assembly 100, 200, 300 may make use of a graphical user interface, or other kind of machine-to-human interface, to carry out embodiments of the functions and features described herein. The processor may include any processor used in smartphones and/or other computing devices, including an analog processor (e.g., a Nano carbon-based processor). In certain embodiments, the processor may include one or more other processors, such as one or more microprocessors, and/or one or more supplementary co-processors, such as math co-processors,

Many different arrangements of the various components depicted, as well as components not shown, are possible without departing from the spirit and scope of the invention. Embodiments of the invention have been described with the intent to be illustrative rather than restrictive. Alternative embodiments will become apparent to those skilled in the art that do not depart from its scope. A skilled artisan may develop alternative means of implementing the aforementioned improvements without departing from the scope of the invention. It will be understood that certain features and subcombinations are of utility and may be employed without reference to other features and subcombinations and are contemplated within the scope of the disclosure.

What is claimed is:

1. A valve assembly, comprising:
a valve body having an inlet port and an outlet port and an integral coil holder positioned between the inlet port and the outlet port;
a coil assembly situated within the coil holder, the coil assembly comprising:
a coil bobbin;
a solenoid coil positioned around the coil bobbin;
a retainer plug secured to a first end of the coil bobbin; and
an assist spring secured to and extending from a second end of the coil bobbin;
a valve poppet assembly, comprising:
a valve poppet;
a magnet situated atop the valve poppet; and
a valve poppet stem in threadable engagement with the valve poppet, the valve poppet stem thereby holding the magnet atop the valve poppet; and
a valve body plug threadably attached to an outlet port end of the valve body, the valve body plug comprising a valve seat;
wherein a distal end of the assist spring is positioned around a portion of the valve poppet, whereby the assist spring biases the valve poppet into a closed position atop the valve seat in a normal state.

2. The valve assembly of claim 1, further comprising a fastener selectively threadably received into the retainer plug through an opening in the coil holder, whereby the coil assembly is held into position within the coil holder.

3. The valve assembly of claim 1, wherein the valve poppet is constructed of a non-magnetic material.

4. The valve assembly of claim 3, wherein the valve poppet stem is constructed of a ferromagnetic material.

5. The valve assembly of claim 4, wherein the retainer plug is constructed of a ferromagnetic material.

6. The valve assembly of claim 1, wherein the valve poppet stem is constructed of a ferromagnetic material.

7. The valve assembly of claim 1, wherein the retainer plug is constructed of a ferromagnetic material.

8. The valve assembly of claim 1, wherein the solenoid coil is configured to selectively receive an electrical current via wires extending through an opening in the valve body.

9. The valve assembly of claim 8, wherein the electrical current selectively induces a magnetic field within the coil thereby influencing the valve poppet assembly to move into an open position wherein a space is created between the valve poppet and the valve seat.

10. The valve assembly of claim 1, wherein the coil bobbin comprises a snap ring, and wherein the snap ring engages with the retainer plug to maintain the retainer plug in position.

11. The valve assembly of claim 1, further comprising a seal disposed between the coil bobbin and the coil holder.

12. The valve assembly of claim 1, further comprising a seal between the valve body plug and the valve body.

13. The valve assembly of claim 1, wherein the assist spring is a conical spring.

14. The valve assembly of claim 1, wherein the magnet is a permanent magnet.

15. A valve assembly, comprising:
a valve body having an inlet port and an outlet port and an integral coil holder positioned between the inlet port and the outlet port;
a coil assembly situated within the coil holder, the coil assembly comprising:
a coil bobbin;
a solenoid coil positioned around the coil bobbin;
a retainer plug secured to a first end of the coil bobbin; and
an assist spring secured to and extending from a second end of the coil bobbin; and
a valve poppet assembly, comprising:
a valve poppet;
a magnet situated atop the valve poppet; and
a valve poppet stem in threadable engagement with the valve poppet, the valve poppet stem thereby holding the magnet atop the valve poppet;
wherein a distal end of the assist spring is positioned around a portion of the valve poppet, whereby the assist spring biases the valve poppet away from the coil bobbin in a natural state.

16. The valve assembly of claim 15, wherein the retainer plug and the valve poppet stem is each separately made of a ferromagnetic material.

17. The valve assembly of claim 15, wherein the magnet is a permanent magnet.

18. The valve assembly of claim 15, wherein the spring is a conical spring.

19. The valve assembly of claim 15, wherein the valve poppet is non-magnetic.

20. A valve assembly, comprising:
a valve body having an inlet port and an outlet port and an integral coil holder positioned between the inlet port and the outlet port;
a coil assembly situated within the coil holder, the coil assembly comprising an assist spring secured to and extending from an end thereof;
a valve body plug threadably attached to an outlet port end of the valve body, the valve body plug comprising a valve seat;
a valve poppet assembly comprising:
a valve poppet;
wherein a distal end of the assist spring is positioned around a portion of the valve poppet, whereby the assist spring biases the valve poppet into a closed position atop the valve seat in a normal state; and
means for causing the valve poppet to move from the closed position into an open position, wherein a space is formed between the valve poppet and the valve seat.
